(19) United States
(12) Patent Application Publication
(10) Pub. No.: US 2022/0256810 A1
(43) Pub. Date: Aug. 18, 2022

(54) SYSTEM AND METHOD OF A HEATED RETRACTABLE DOG LEASH

(71) Applicant: Thomas H. HUGHES, III, Silver Spring, MD (US)

(72) Inventor: Thomas H. HUGHES, III, Silver Spring, MD (US)

(21) Appl. No.: 17/518,532

(22) Filed: Nov. 3, 2021

Related U.S. Application Data
(60) Provisional application No. 63/199,599, filed on Feb. 12, 2021.

(51) Int. Cl. A01K 27/00; H05B 1/02

(52) U.S. Cl. CPC A01K 27/004; H05B 1/0252

(57) ABSTRACT

A heated retractable leash is disclosed which increases the comfort of the user by heating the housing of the retractable leash during cold or inclement weather.

### FIELD OF THE INVENTION

The present invention relates to the field of dog leashes, specifically, a heated retractable dog leash.

### BACKGROUND OF THE INVENTION

For centuries people have had a need to restrain and control their pets, such as their dogs, whenever they walk these pets. In ancient times, specifically Pompeii, Cave Canem, the famous mosaic also known as ‘beware of the dog’ depicts a collared dog on a leash. Although contrary to the fabric leashes, we have now, the leash depicted is more of a chain. In Ancient Greece, collars were a form of protection for the dogs. They would have spikes going outwards from the dog's neck so that if a wolf tried to bite the dog's neck, the wolf would be the one injured.

In the 18^{th} century, dogs strayed away from being used for sport and shifted back to pampered pets. Instead of spiked collars that had become so popular, dog owners began to use a more recognizable trend of using collars that have the owner's name on it. So that if lost, the dog could be returned to the owner. In the year 1908, Mary A. Delaney created the first retractable leash, she described it saying “the objects of the present invention are to obviate and overcome all these difficulties and annoyances due to the usual form of leash, and prevent the leash from becoming tangled as the dog runs about.”

Some might even say that dogs like leashes or collars if their owners use them properly. Leashes should be in the correct size, if used for a small dog, the leash should be thinner than one that would be used for a larger dog.

Typically, people use some sort of leash to restrain and control their pets during these outings. Over the years, companies have developed and manufactured many distinct types of leashes for individuals to walk their pets. These prior leashes include retractable leashes, leashes to walk multiple pets simultaneously, elongated leashes, and leashes which utilize diverse ways in which the leash is attached to the pet's collar. Considering the requirements of many states, counties, cities, and municipalities to use leashes when an owner takes his/her pet outside, the demand for several types of leashes has increased.

### SUMMARY OF THE INVENTION

A heated retractable leash including a housing including a handle, a leash including a fastening device on one end and wherein a majority of said leash can be retracted into said housing, a rechargeable battery located inside a portion of said housing, a charging port located on a surface of said housing, at least one heating element located within said handle of said housing, a control switch capable of interrupting the flow of electricity from said rechargeable battery to said at least one heating element.

The heated retractable leash described above further including one or more function indicator lights which may be used to indicate the level of heat applied to a handle of said heated retractable leash.

The heated retractable leash described above further including a means to prevent the pet from extracting additional leash portion from the housing.

### BRIEF DESCRIPTION OF THE DRAWINGS

In the drawings, like reference characters refer to the same parts throughout the different views. The drawings are not necessarily to scale, the emphasis of the drawings is being placed upon illustrating the principles of various embodiments of the invention. The foregoing and other aspects of the invention will be better understood from the following description of embodiments of the invention, by way of example only, and with reference to the accompanying drawings, in which:

FIG. 1 is an illustration of one embodiment of a heated retractable dog leash with multiple enhancements.

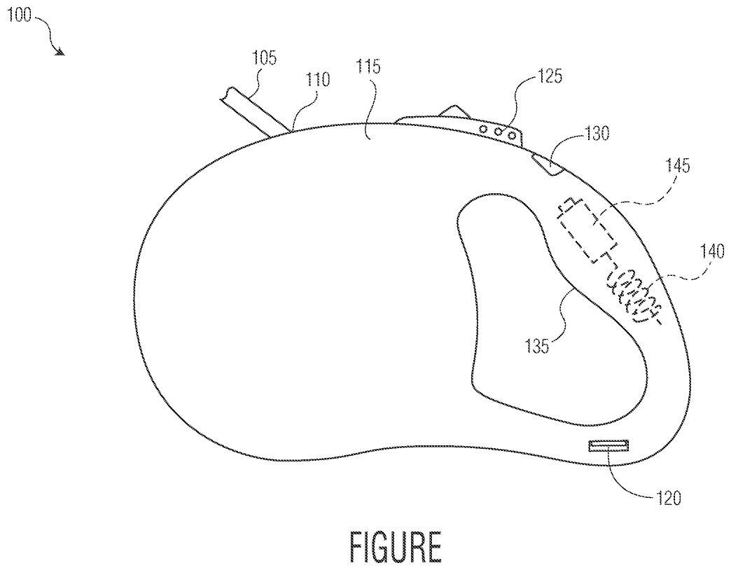

### DETAILED DESCRIPTION OF THE INVENTION

In the following detailed description, reference will be made in detail to the preferred embodiments of the present invention, examples of which are illustrated in the accompanying drawing, which form a part hereof and show by way of illustration embodiments in which the invention may be practiced. These embodiments are described in sufficient detail to enable those skilled in the art to practice the invention, and it is to be understood that other embodiments may be utilized, and that structural, logical, and electrical changes may be made without departing from the spirit and scope of the present invention. The progression of processing steps described (if any) is exemplary of embodiments of the invention; however, the sequence of steps is not limited to that set forth herein and may be changed as is known in the art, except for steps necessarily occurring in a certain order.

The FIGURE shows one embodiment of the present invention of a heated retractable dog leash.

As shown in the FIGURE, a heated retractable dog leash 100, includes leash portion 105 which is used to attach the heated retractable dog leash 100 to the dog (now shown). The attachment to the dog is typically done by clipping an end portion of the leash portion 105 to the dog's collar—which normally contains a D-ring (or other device) which is affixed to the dog collar and permits attachment of a fastening means attached to the end of the leash portion 105. The leash portion 105 passes through an opening 110 in the heated retractable dog leash and the heated retractable dog leash normally includes a spool or similar mechanism for storing the portion of the leash portion 105 which is contained within the heated retractable dog leash. A substantial portion of the leash portion may be easily extendable to permit the dog (or similar pet) to move away from the pet's owner without substantial difficulty.

Located within the housing 115 of the heated retractable dog leash is one or more internal heating elements 140 which, when activated, can be used to heat the housing 115, or a portion of the housing 115, of the heated retractable dog leash for when the pet's owner (or other dog walker) is walking the dog in cold or wet conditions. The one or more internal heating 140 elements are connected to an internal rechargeable battery 145 which is electrically connected to an Universal Serial Bus (USB) charging port 120, or a similar method for charging the internal rechargeable battery or batteries.

In one embodiment, one or more function indicator lights 125 are located on the housing 115, which may be used to indicate the current heating settings. In one embodiment three function indicator lights are available where the illumination of one light is used to indicate a first level of warmth, the illumination of two lights is used to indicate a second level of warmth (generally warmer than the first level of warmth) and three lights are used to indicate a third level of warmth (generally warmer then the first level of warmth of the second level of warmth). The function indicator lights may be used to show the dog walker just how warm and toasty their hands will be as they walk their dog during cold or inclement weather.

In one embodiment, directly below the function indicator lights 125, is the control switch 130 which may be used to allow the user to switch between the three levels of warmth available. One of ordinary skill in the art would understand that additional levels of warmth could be included in the present invention without departing from the scope of the current invention. One embodiment of the present invention may include two levels of warmth while other embodiments of the invention may include six, seven, or more levels of warmth. The control switch 130 may be implemented with a push button, or a thumb switch or any other manner to control turning the warmth feature of the heated retractable dog leash from on to off (or vice versa) and for changing the level of warmth available.

As previously mentioned, typically the rechargeable battery 145 is located within the housing 115 of the heated retractable dog leash. The present invention envisions having different levels of rechargeable batteries available for purchase for the heated retractable dog leash. One embodiment of heated retractable dog leash may include a rechargeable battery which will continue to provide heat in subzero degree weather for period of time in excess of two hours. Other embodiments of the heated retractable dog leash may include a smaller rechargeable battery which would result in a heated retractable dog leash which would weigh less. In one embodiment, the heated retractable dog leash is sold without the inclusion of the rechargeable battery and the purchaser may purchase the rechargeable battery of his/her choice to meet the conditions in which the user expects to use the heated retractable dog leash. In one embodiment, the housing 115 is configured to be able to hold rechargeable batteries of different storage capacity so that one housing may be used in different areas of the country. In another embodiment, different housings are used to accommodate rechargeable batteries of different storage capacity. If the rechargeable battery is running low on power, the user may be able to transfer some of the battery power available from their other electronic devices to the heated rechargeable dog leash. Similarly, if the batter power of other electronic devices begins to run low, the user will be able to transfer a portion of the battery power stored in the heated retractable dog leash to the other electronic device. For example, and without limitation, if a user's cellular phone is running low on power, the user may be able to connect a wire between the heated retractable dog leash and the cellular phone to transfer some of the stored electrical power of the heated retractable dog leash to the cellular phone. Alternatively, if the heated retractable dog leash was lower on power, the user may decide to transfer some of the electrical power stored in the cellular phone to the heated retractable dog leash.

In the embodiment shown, the USB Charging port 120 is located where, if needed, the dog walker can charge his or her phone for emergencies.

The housing 115 of the heated retractable dog leash 100 may also include a molded grip 135 to provide more comfort to the user of the heated retractable dog leash.

The heated retractable dog leash 110 may also include an arresting button (not shown) which will lock the leash portion and prevent the dog from pulling on the leash portion to increase the length of the leash located outside the housing 115.

One of ordinary skill in the art would understand that the internal components of the heated retractable dog leash would be similar to a battery-powered hand warmer.

While the invention has been particularly shown with reference to specific embodiments, it should be understood by those of ordinary skill in the art that various changes in form and detail may be made therein without departing from the spirit and scope of the invention as defined by the claims. The invention is to cover all modifications, equivalents, and alternatives falling within the spirit and scope of the invention as defined by the claims.

1. A heated retractable leash comprising:
a housing including a handle,
a leash including a fastening device on one end and wherein a majority of said leash can be retracted into said housing,
a rechargeable battery located inside a portion of said housing,
a charging port located on a surface of said housing,
at least one heating element located within said handle of said housing,
a control switch capable of interrupting the flow of electricity from said rechargeable battery to said at least one heating element.

2. The heated retractable leash of claim 1 including:
One or more function indicator lights which may be used to indicate the level of heat applied to a handle of said heated retractable leash.

3. The heated retractable leash of claim 1 further including a means to prevent the pet from extracting additional leash portion from the housing.
